(19) United States
(12) Patent Application Publication
(10) Pub. No.: US 2010/0309594 A1
(43) Pub. Date: Dec. 9, 2010

(54) INTEGRATED CIRCUIT DEVICE

(75) Inventors: Hirohiko SADAMATSU, Yokohama (JP); Tetsuji Funaki, Yokohama (JP); Norio Nagase, Yokohama (JP)

Correspondence Address: Fujitsu Patent Center;Fujitsu Management Services of America, Inc., 2318 Mill Road, Suite 1010, Alexandria, VA, 22314, US

(73) Assignee: FUJITSU SEMICONDUCTOR LIMITED, Yokohama-shi (JP)

(21) Appl. No.: 12/793,635

(22) Filed: Jun. 3, 2010

(30) Foreign Application Priority Data
Jun. 5, 2009 (JP) 2009-135755

(51) Int. Cl. H02H 9/04

(52) U.S. Cl. 361/56

(57) ABSTRACT

An integrated circuit device includes a first power supply domain and a second power supply domain, wherein the first power supply domain includes a first power supply line and a second power supply line, an internal circuit between the first power supply line and the second power supply line, a first clamp circuit that electrically couples between the first power supply line and the second power supply line when a certain potential difference is generated between the first power supply line and the second power supply line, and at least one of a junction element that is between the first clamp circuit and the first power supply line and a junction element that is between the first clamp circuit and the second power supply line, the junction element allowing current to flow when the first clamp circuit becomes electrically conductive.

### CROSS-REFERENCE TO RELATED APPLICATION

This application is based upon and claims the benefit of priority of the prior Japanese Patent Application No. 2009-135755, filed on Jun. 5, 2009, the entire contents of which are incorporated herein by reference.

### FIELD

The embodiments discussed herein relate to an integrated circuit device including a clamp circuit.

### BACKGROUND

IC devices include power clamp circuits (hereinafter also referred to as “clamp circuits”) that become electrically conductive when the voltage between power supply lines reaches a certain threshold voltage or higher. A clamp circuit is a circuit that protects elements of an internal circuit against damage caused by electrostatic discharge (ESD). When static electricity is applied between any external terminals of an IC device, a power clamp circuit between an internal power supply line and a ground line becomes electrically conductive and forms a path through which the static electricity flows, thereby reducing if not preventing application of the static electricity to an internal circuit of the IC device.

Power clamp circuits for protecting the IC device from ESD are described in, for example, Japanese Laid-open Patent Publication No. 2008-311433 and Japanese Laid-open Patent Publication No. 2005-203736.

A power clamp circuit includes, for example, an ESD detection circuit that temporarily outputs an “H” level signal upon application of ESD at a high potential to a power supply line, and a transistor that becomes electrically conductive due to the output of the ESD detection circuit. By increasing the size of the transistor so that the current of ESD may flow through the transistor, the internal circuit may be protected against damage caused by the application of ESD at the high potential.

The IC device includes an IC chip and a package that includes the IC chip. When an external terminal of the package and a terminal of the IC chip are coupled by wire bonding to reduce costs, the wire bonding and the power clamp circuit may adversely affect the characteristics of an internal radio-frequency (RF) circuit.

The wire bonding has parasitic inductance and the power clamp circuit has parasitic capacitance. A parasitic inductor and a parasitic capacitor form a resonant circuit that has a certain resonant frequency. When the resonant frequency is within a frequency band of a signal of the internal RF circuit, a noise signal is generated at the power supply line and the ground line due to the operation of the RF circuit and resonates at the resonant frequency. As a result, the characteristics of the RF circuit deteriorate in the resonant frequency band, and no appropriate RF signal may be output, resulting in a malfunction.

The resonant frequency is proportional to the reciprocal of √LC. Thus, the resonant frequency may be shifted to outside of the signal frequency band of the RF circuit, without increasing the circuit area, by reducing the size of the transistor of the power clamp circuit and thereby reducing the parasitic capacitance C. However, ESD may not be sufficiently absorbed when the size of the transistor is reduced.

### SUMMARY

According to an aspect of the embodiments, an integrated circuit device includes a first power supply domain, and a second power supply domain coupled to the first power supply domain via bidirectional diode pairs, wherein the first power supply domain includes a first power supply line and a second power supply line, an internal circuit between the first power supply line and the second power supply line, a first clamp circuit that electrically couples between the first power supply line and the second power supply line when a certain potential difference is generated between the first power supply line and the second power supply line, and at least one of a junction element that is between the first clamp circuit and the first power supply line and a junction element that is between the first clamp circuit and the second power supply line, the junction element allowing current to flow when the first clamp circuit becomes electrically conductive.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a perspective view of an IC device according to embodiments.

FIG. 2 illustrates a power clamp circuit of FIG. 1 and a resonant circuit of FIG. 1;

FIG. 3 illustrates a frequency characteristic of an RF circuit of FIG. 2;

FIG. 4 illustrates an IC device with a power clamp circuit according to a first embodiment;

FIG. 5 illustrates an example of an RF circuit;

FIG. 6 illustrates the results of a simulation for the embodiment;

FIG. 7 illustrates the structure of an IC device according to a second embodiment;

FIG. 8 illustrates a modification of the second embodiment;

FIG. 9 illustrates the details of the IC device according to the second embodiment;

FIG. 10 illustrates the details of an IC device according to a third embodiment;

FIGS. 11A, 11B, and 11C illustrate combinations of a clamp circuit and junction elements according to the embodiments; and

FIGS. 12A, 12B, 12C, and 12D illustrate structures of a clamp circuit according to the embodiments.

### DESCRIPTION OF THE EMBODIMENTS

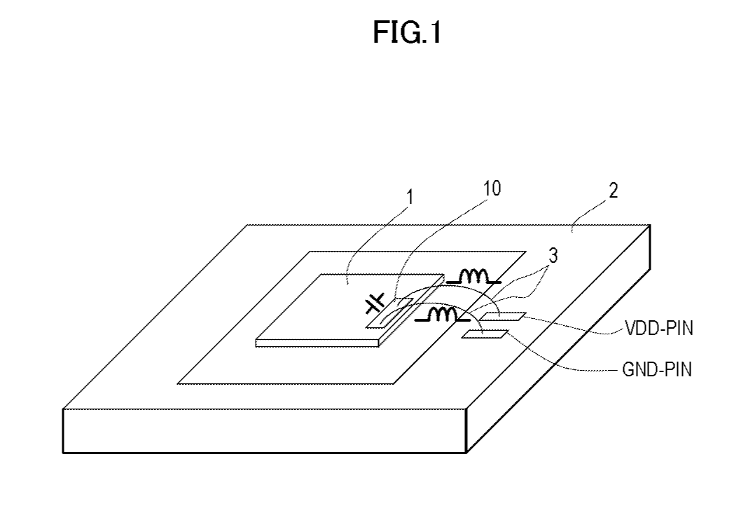

FIG. 1 is a perspective view of an IC device according to embodiments. The IC device includes an IC chip 1, a package 2 that includes the IC chip 1, and bonding wires 3 that couple external terminals of the package 2, for example, a power supply external terminal VDD-PIN and a reference voltage external terminal GND-PIN, to the IC chip 1. The bonding wires 3 are used to reduce the cost of an IC device. The cost of the bonding wires 3 is lower than a cost of a flip chip type that directly couples a terminal of an IC chip to an external terminal of a package.

The IC chip 1 includes a power supply line, a reference voltage line (e.g., a ground line), and various internal circuits that are coupled between the power supply line and the reference voltage line. The IC chip 1 includes a power clamp circuit 10 that protects circuit elements of the internal circuits from electrostatic discharge (ESD). The power clamp circuit 10 includes a clamp transistor that becomes electrically conductive when a voltage difference between the power supply line and the reference voltage line exceeds a certain threshold. The clamp transistor forms a parasitic capacitance between the power supply line and the reference voltage line. The value of the parasitic capacitance may not be ignored when the clamp transistor has a size larger than or equal to a certain size. At substantially the same time, the bonding wires 3 are electrically conductive wires with a small cross section and have parasitic inductances that may not be ignored.

The parasitic capacitance of the power clamp circuit 10 and the parasitic inductances of the bonding wires 3 form a resonant circuit that has a certain resonant frequency. When the resonant frequency of the resonant circuit is within the frequency band of a signal of an internal RF circuit, adverse effects are exerted on the characteristics of the RF circuit.

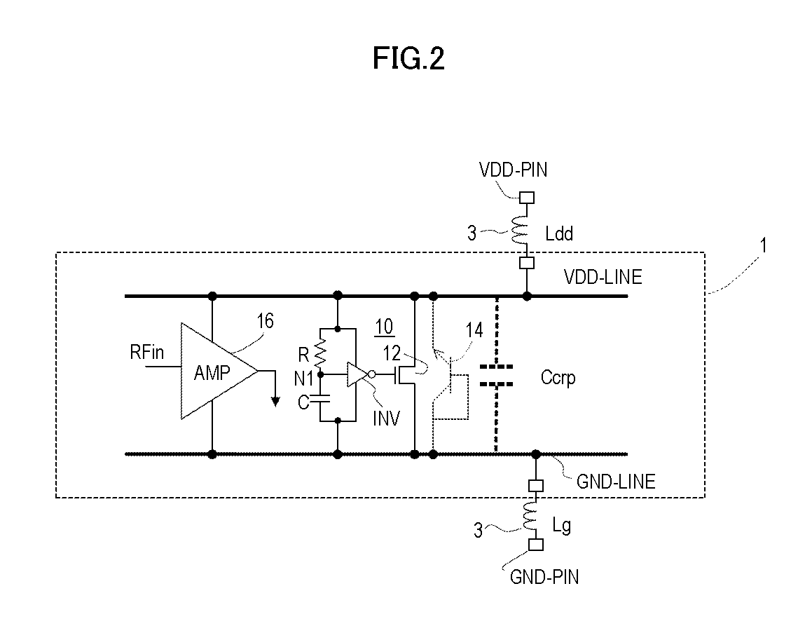

FIG. 2 illustrates the power clamp circuit 10 of FIG. 1 and the resonant circuit of FIG. 1. The IC chip 1 includes the power supply line VDD-LINE coupled to the power supply external terminal VDD-PIN via one of the bonding wires 3, the reference voltage line (e.g., ground line) GND-LINE coupled to the reference voltage external terminal GND-PIN via another one of the bonding wires 3, and an RF circuit 16 that is electrically coupled between the power supply line VDD-LINE and the reference voltage line GND-LINE and that processes an RF signal RFin. The IC chip 1 includes the power clamp circuit 10, which is electrically coupled between the power supply line VDD-LINE and the reference voltage line GND-LINE and which becomes electrically conductive when a voltage difference between the power supply line VDD-LINE and the reference voltage line GND-LINE exceeds a certain threshold.

The power clamp circuit 10 includes a clamp transistor 12 that absorbs electric charge when ESD is generated between the power supply line VDD-LINE and the reference voltage line GND-LINE. The clamp transistor 12 is, for example, an N-channel metal oxide semiconductor (MOS) transistor. The power clamp circuit 10 includes, for example, an ESD detection circuit. The ESD detection circuit includes a resistor R, a capacitor C, and a complementary metal-oxide semiconductor (CMOS) inverter INV that outputs “H” level signal to a gate of the clamp transistor 12 to make the clamp transistor 12 electrically conductive when a voltage difference between the power supply line VDD-LINE and the reference voltage line GND-LINE exceeds a certain threshold.

In a normal operating state, an internal voltage of about 3.0 V is applied to the power supply line VDD-LINE. Thus, a node N1 between the resistor R and the capacitor C is at “H” level, and an output of the inverter INV is at “L” level. Therefore, the clamp transistor 12 is not electrically conductive. Application of ESD to any of the external terminals of the IC device in FIG. 1 causes the voltage difference between the power supply line VDD-LINE and the ground line GND-LINE to instantaneously reach a certain threshold voltage or greater due to an internal circuit path (not illustrated). Accordingly, the node N1 enters and is maintained at an “L” level state relative to the inverter INV for a certain amount of time, and the output of the inverter INV reaches becomes “H” level. As a result, the clamp transistor 12 becomes electrically conductive. Accordingly, a large quantity of electric charge due to ESD between the power supply line VDD-LINE and the ground line GND-LINE flows through the clamp transistor 12, thereby reducing if not preventing an excessive increase in the voltage difference between the power supply line VDD-LINE and the ground line GND-LINE. Application of an excessively high voltage to circuit elements, for example, transistors of the internal circuits, is reduced if not prevented. The ESD detection circuit is designed not to allow the clamp transistor 12 to become electrically conductive upon application of very small noise, for example, power supply noise.

As illustrated in FIG. 2, a PN diode (not illustrated) between a base and an emitter of a parasitic diode 14 of the clamp transistor 12, which is an N-channel MOS transistor, becomes electrically conductive when the potential of the ground line GND-LINE side increases more than a potential of the power supply line VDD-LINE due to ESD. Current flows in the reverse direction, and the electric charge is absorbed. That is, the clamp transistor 12 is configured to absorb electric charge in two directions.

The clamp transistor 12 has a parasitic capacitance Ccrp between a drain and a source. The parasitic capacitance Ccrp is present between the power supply line VDD-LINE and the ground line GND-LINE. At substantially the same time, the bonding wires 3 have parasitic inductances Ldd and Lg. Therefore, the parasitic capacitance Ccrp of the clamp transistor 12 and the parasitic inductances Ldd and Lg of the bonding wires 3 form a resonant circuit at the power supply line VDD-LINE and the ground line GND-LINE.

The internal RF circuit 16 is an RF amplifier that amplifies, for example, an RF input signal RFin. The RF circuit 16 receives an RF input signal RFin and amplifies the RF input signal RFin. In accordance with the amplification by the internal RF circuit 16, a noise signal is generated at the power supply line VDD-LINE and the ground line GND-LINE. When the frequency of the noise signal overlaps the resonant frequency, the noise signal is resonated by the previously described resonant circuit including the parasitic capacitance Ccrp and the parasitic inductances Ldd and Lg.

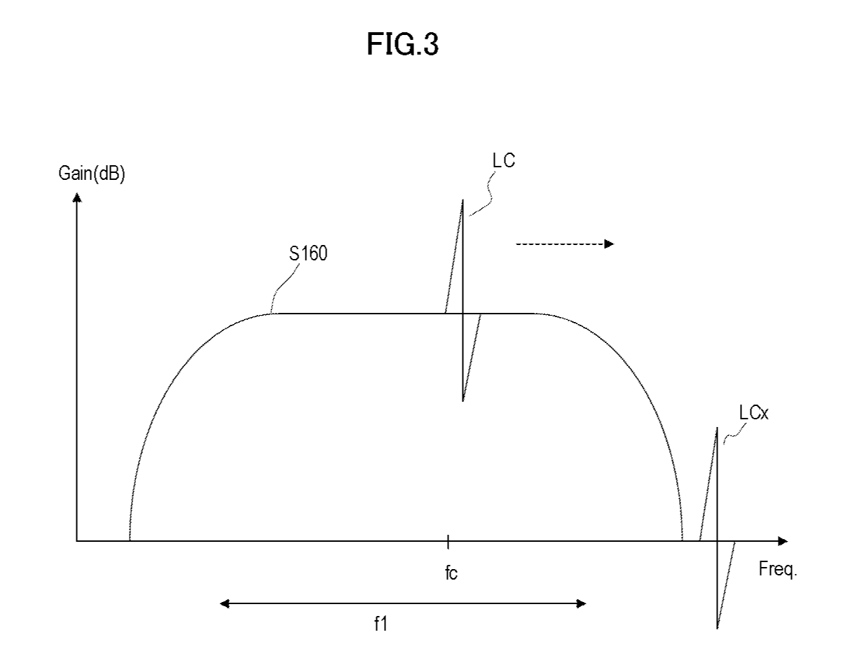

FIG. 3 is a graph illustrating a frequency characteristic of the RF circuit 16 of FIG. 2. In the graph, frequency is plotted in abscissa, and gain of the RF amplifier in FIG. 2 is plotted in ordinate. A frequency characteristic S160 of the RF amplifier in FIG. 2 is illustrated as an example of the frequency characteristic. The frequency characteristic has a certain gain for a signal in a certain frequency band. However, when a resonant circuit is formed by the parasitic inductances and the parasitic capacitance at the power supply line VDD-LINE and the ground line GND-LINE to which the RF amplifier in FIG. 2 is coupled as illustrated in FIG. 2, LC resonance occurs at a resonant frequency fc of the resonant circuit, and gain fluctuation occurs, as indicated by LC in the graph. The gain characteristic fluctuation indicates that the RF amplifier in FIG. 2 may not generate the desired output, resulting in a malfunction of the internal circuits.

Therefore, a shift of the resonant frequency fc is desired in order not to give rise to characteristic fluctuation caused by the LC resonance within a signal frequency band fl of the RF circuit 16. The resonant frequency fc may be shifted by changing the parasitic inductances of the bonding wires 3 in FIG. 2 or changing the parasitic capacitance of the clamp transistor 12 in FIG. 2. However, the parasitic inductances of the bonding wires 3 are difficult to be changed or reduced because the number of wires may be necessary. Reduction of the parasitic capacitance of the clamp transistor 12 may not be preferable in regard to ESD protection because a reduction of the clamp transistor 12 size may be necessary. An increase in the parasitic capacitance of the clamp transistor 12 may also not be preferable because an increase in area of the clamp transistor 12 may be necessary and the effects on changing the resonant frequency fc may not be sufficient. A dashed line arrow in FIG. 3 indicates the direction in which the resonant frequency fc is shifted when the parasitic capacitance is reduced.

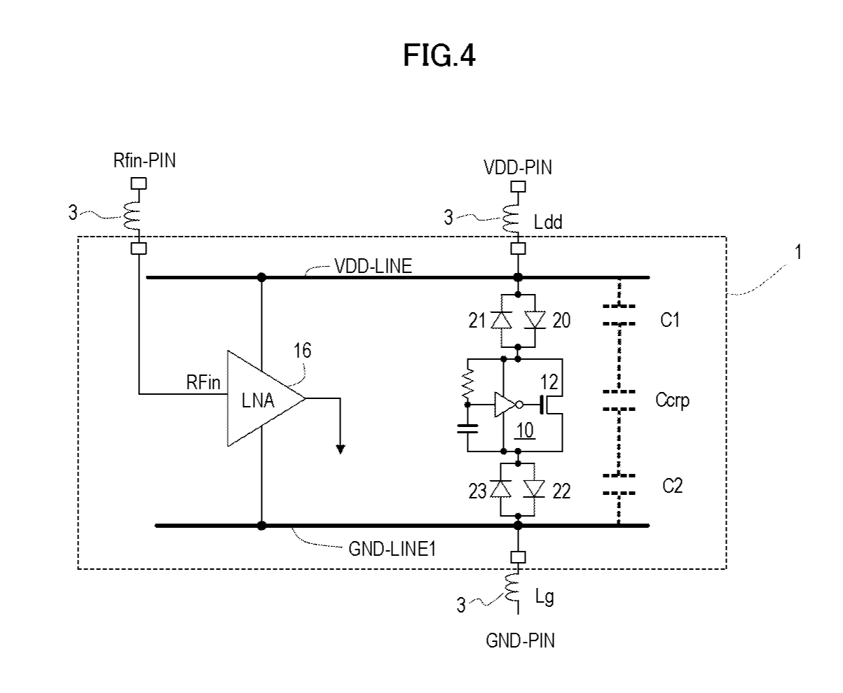

FIG. 4 is an IC device with a power clamp circuit according to a first embodiment. The IC device includes the IC chip 1 in a package (not illustrated). The external terminals VDD-PIN, GND-PIN, and RFin-PIN of the package are coupled by the bonding wires 3 to corresponding terminals of the IC chip 1.

The power supply line VDD-LINE and the ground line GND-LINE are in the IC chip 1. An internal circuit (e.g., RF circuit 16) is coupled to the power supply line VDD-LINE and the ground line GND-LINE. A low-noise amplifier LNA that amplifies an RF input signal RFin input from the RF input terminal RFin-PIN is illustrated as the RF circuit 16. The power clamp circuit 10 with the clamp transistor 12 illustrated in FIG. 2 is between the power supply line VDD-LINE and the ground line GND-LINE.

A bidirectional diode pair 20 and 21 is between the clamp transistor 12 and the power supply line VDD-LINE, and a bidirectional diode pair 22 and 23 is between the clamp transistor 12 and the ground line GND-LINE. These diodes 20, 21, 22, and 23 are junction elements that have junction capacitances C1 and C1 and allow current to flow when the clamp transistor 12 becomes electrically conductive. That is, electric charge flows from the power supply line VDD-LINE to the ground line GND-LINE via the diodes 20 and 22 and the clamp transistor 12 when the gate of the clamp transistor 12 becomes “H” level and the clamp transistor 12 is turned ON. Also, electric charge flows from the ground line GND-LINE to the power supply line VDD-LINE via the diodes 23 and 21 and the parasitic diode 14 (FIG. 2) of the clamp transistor 12 when the parasitic diode 14 is turned ON.

As previously described, the presence of the bidirectional diode pairs has no adverse effect on the operation of the power clamp circuit 10 in regard to ESD protection. At substantially the same time, since the bidirectional diode pairs are junction elements that have PN junction, their junction capacitances are present as the parasitic capacitances C1 and C2. These parasitic capacitances C1 and C2 are coupled in series to the parasitic capacitance Ccrp of the clamp transistor 12. As a result, the parasitic capacitance between the power supply line VDD-LINE and the ground line GND-LINE may be reduced more than when there are no diode pairs.

The previously described bidirectional diode pairs 20 and 21, and 22 and 23 may not be bidirectional. For example, when there are the diodes 20 and 22, ESD protection may be performed when the potential of the power supply line VDD-LINE increases more than that of the ground line GND-LINE. At substantially the same time, the parasitic capacitance, between the power supply line VDD-LINE and the ground line GND-LINE, of the power clamp circuit 10 may be reduced. In contrast, when there are the diodes 23 and 21, ESD protection may be performed when the potential of the ground line GND-LINE increases more than that of the power supply line VDD-LINE. Similarly, the parasitic capacitance, between the power supply line VDD-LINE and the ground line GND-LINE, of the power clamp circuit 10 may be reduced.

A plurality of diode pairs 20 and 21, and 22 and 23 may be coupled in series when the voltage difference between the power supply and the ground is sufficient. Accordingly, plural parasitic capacitances of the diodes 20, 21, 22, and 23 are coupled in series to the parasitic capacitance Ccrp of the clamp transistor 12, thereby further reducing the overall parasitic capacitance.

Alternatively, a diode pair may be between the power clamp circuit 10 and the power supply line VDD-LINE, or a diode pair may be between the power clamp circuit 10 and the ground line GND-LINE. In either case, the parasitic capacitance between the power supply lines of the power clamp circuit 10 may be reduced.

As previously described, the parasitic capacitance between the power supply line VDD-LINE and the ground line GND-LINE of the clamp transistor 12 may be reduced by providing, between the clamp transistor 12 and the power supply line VDD-LINE and/or between the clamp transistor 12 and the ground line GND-LINE, junction elements that allow current to flow when the clamp transistor 12 becomes electrically conductive. As a result, the resonant frequency of the resonant circuit formed by the parasitic capacitance of the clamp transistor 12 and the parasitic inductances of the bonding wires 3 of the power supply VDD and the ground GND may be further shifted. For example, as illustrated in FIG. 3, the characteristic due to the resonant circuit is shifted to a position indicated by LCx in the graph, which is outside the signal frequency band fl of the RF circuit 16. At substantially the same time, the size of the clamp transistor 12 may be made sufficiently large enough for taking preventative measures against ESD.

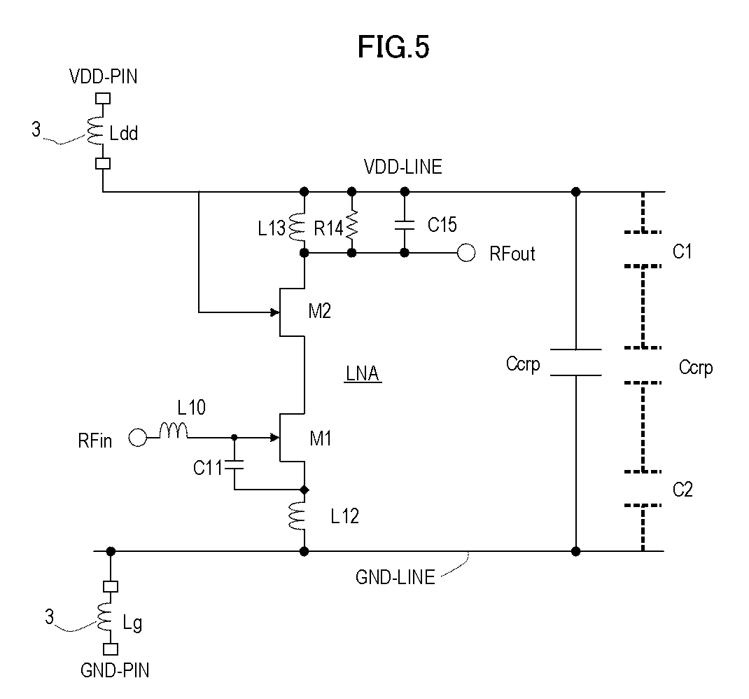

FIG. 5 is a diagram illustrating an example of the RF circuit 16 of FIG. 4. An example of a low-noise amplifier LNA is illustrated in FIG. 5. The low-noise amplifier LNA includes a source-grounded transistor M1 whose source is coupled to the ground line GND-LINE via an inductor L12, a gate-grounded transistor M2 whose source is coupled to the drain of the transistor M1 and whose gate is coupled to the power supply line VDD-LINE, and a load circuit L13, R14, and C15. A capacitor C11 is between the gate and source of the transistor M1, and an RF input signal RFin is input to the gate via an inductor L10.

The transistors M1 and M2 of the low-noise amplifier LNA perform amplifying operation in accordance with fluctuation of the RF input signal RFin, and the low-noise amplifier LNA outputs an amplified RF output signal RFout from an output terminal at the node between the load circuit L13, R14, and C15 and the gate-grounded transistor M2. With the operation of the low-noise amplifier LNA, a noise signal is generated at the power supply line VDD-LINE and the ground line GND-LINE.

The noise signal is resonated in the resonant frequency band by the resonant circuit formed by the parasitic inductances Ldd and Lg of the bonding wires 3 and the parasitic capacitance Ccrp of the clamp transistor 12. With the resonant operation, for example, the potential of power supply fluctuates, and the gain of the low-noise amplifier LNA increases or decreases, as illustrated in FIG. 3.

In the present embodiment, as illustrated in FIG. 4, diodes are in series between the clamp circuit 10 and the power supply line VDD-LINE and/or the ground line GND-LINE. Accordingly, the parasitic capacitance Ccrp between the power supply line VDD-LINE and the ground line GND-LINE is reduced, thereby shifting the resonant frequency band to the outside of the signal frequency band of the RF circuit 16.

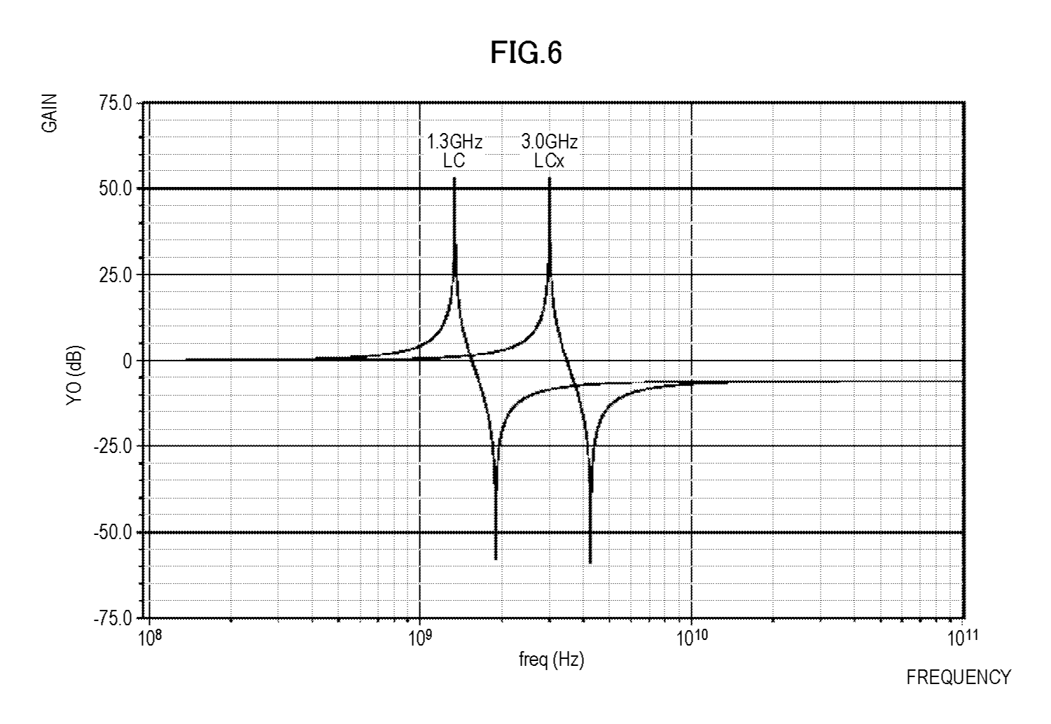

FIG. 6 is a graph illustrating the results of a simulation, of the first embodiment of FIG. 4, conducted by the inventors of the embodiments. The simulation was conducted with the parasitic capacitance Ccrp of the power clamp circuit 10 (clamp transistor 12) being 10 pF, the inductances Ldd and Lg of the bonding wires 3 being 0.7 nH and 0.7 nH, and the junction capacitances C1 and C2 of the bidirectional diodes being 5 pF and 5 pF. A resonant frequency LC was 1.3 GHz when there were no bidirectional diodes, whereas a resonant frequency LCx was 3.0 GHz when there were bidirectional diodes. Therefore, the resonant frequency was shifted to the outside of, for example, a signal frequency band of 1 to 1.6 GHz of the RF circuit 16.

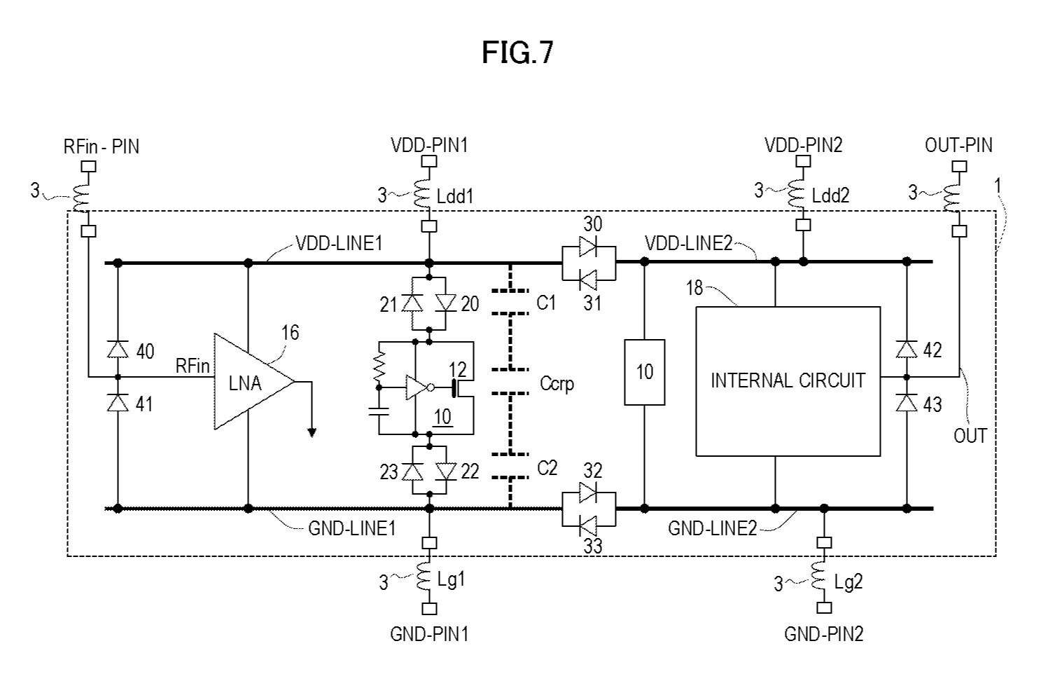

FIG. 7 is a diagram illustrating the structure of a semiconductor IC device according to a second embodiment. In the second embodiment, the IC chip 1 has a plurality of power supply domains. That is, a first power supply domain includes a first power supply line VDD-LINE1 and a ground line GND-LINE1. These distribution lines VDD-LINE1 and GND-LINE1 are coupled to external terminals VDD-PIN1 and GND-PIN1, respectively, of the package via bonding wires 3. Also, a second power supply domain includes a second power supply line VDD-LINE2 and a ground line GND-LINE2. These distribution lines VDD-LINE2 and GND-LINE2 are coupled to external terminals VDD-PIN2 and GND-PIN2, respectively, of the package via bonding wires 3.

The RF circuit 16 is in the first power supply domain. An internal circuit 18 is in the second power supply domain. An input RFin of the RF circuit 16 is coupled to an external terminal RFin-PIN and is coupled to the power supply line VDD-LINE1 and the ground line GND-LINE1 via diodes 40 and 41, respectively. One power clamp circuit 10, illustrated in FIG. 4, is coupled between the power supply line VDD-LINE1 and the ground line GND-LINE1 in the first power supply domain via the diode pairs 20 and 21, and 22 and 23.

The internal circuit 18 is in the second power supply domain. An output OUT of the internal circuit 18 is coupled to an external terminal OUT-PIN and is coupled to the power supply line VDD-LINE2 and the ground line GND-LINE2 via diodes 42 and 43, respectively. Another power clamp circuit 10 is between the power supply line VDD-LINE2 and the ground line GND-LINE2. The internal circuit 18 is a circuit at a frequency lower than that of the RF circuit 16. A resonant frequency due to the parasitic capacitance of the power clamp circuit 10 and the parasitic inductances of the bonding wires 3 is outside the frequency band of the internal circuit 18.

The power supply domains are separated in the IC chip 1 in order not to allow power supply noise generated by the operation of an internal circuit in one power supply domain to affect an internal circuit in the other power supply domain. Also, power-saving effects are achieved by performing individual power supply control of the power supply domains.

A bidirectional diode pair 30 and 31 is between the power supply lines VDD-LINE1 and VDD-LINE2 of the power supply domains. Similarly, a bidirectional diode pair 32 and 33 is between the ground lines GND-LINE1 and GND-LINE2. These bidirectional diode pairs 30 and 31, and 32 and 33 do not become electrically conductive due to small noise generated at the power supply lines VDD-LINE1 and VDD-LINE2 and the ground lines GND-LINE1 and GND-LINE2 of the power supply domains. These bidirectional diode pairs 30 and 31, and 32 and 33 electrically separate the power supply lines VDD-LINE1 and VDD-LINE2 and the ground lines GND-LINE1 and GND-LINE2 of the power supply domains, thereby reducing if not preventing transfer of power supply noise from one power supply domain to the other power supply domain. However, these bidirectional diode pairs 30 and 31, and 32 and 33 become electrically conductive upon generation of large power supply noise, thereby causing the power clamp circuits 10 to absorb the electrical charge of the noise and protecting the IC device against damage caused by ESD.

For example, upon application of ESD between the power supply external terminal VDD-PIN2 and the ground external terminal GND-PIN2 (VDD-PIN2 is at a high potential), the electric charge is absorbed by a path of VDD-PIN2, VDD-LINE2, the diodes 31 and 20, the power clamp circuit 10, the diode 22, GND-LINE1, and GND-PIN1 in the respective order. The electric charge is further absorbed by a path of VDD-PIN2, VDD-LINE2, the power clamp circuit 10, the diode 33, GND-LINE1, and GND-PIN1 in the respective order. Upon application of ESD between the input signal external terminal RFin-PIN and the ground external terminal GND-PIN2 (RFin-PIN is at a high potential), the electric charge is absorbed by a path of RFin-PIN, the diode 40, VDD-LINE1, the diode 30, the power clamp circuit 10, GND-LINE2, and GND-PIN2 in the respective order.

As previously described, the bidirectional diode pairs 30 and 31, and 32 and 33 between the power supply lines and the ground lines have two functions: to cut off flow between the power supply lines and to protect from ESD.

The RF circuit 16 is coupled to the power supply line VDD-LINE1 and the ground line GND-LINE1 of the first power supply domain. The resonant operation of a resonant circuit formed by parasitic inductances Ldd1 and Lg1 of the bonding wires 3 of the power supply line VDD-LINE1 and the ground line GND-LINE and by the parasitic capacitance of the power clamp circuit 10 has adverse effects on the characteristics of the RF circuit 16. A resonant signal generated at the power supply line VDD-LINE2 and the ground line GND-LINE2 of the second power supply domain has no adverse effects on the characteristics of the RF circuit 16 in the first power supply domain.

In the second embodiment illustrated in FIG. 7, the power clamp circuit 10 between the power supply line VDD-LINE1 and the ground line GND-LINE1 to which the RF circuit 16 is directly coupled is coupled between the power supply line VDD-LINE1 and the ground line GND-LINE1 via the junction elements 20, 21, 22, and 23, thereby reducing the parasitic capacitance between the power supply line VDD-LINE1 and the ground line GND-LINE1. Accordingly, the signal frequency band of a resonant signal generated at the power supply line VDD-LINE1 and the ground line GND-LINE1 of the first power supply domain is shifted to the outside of the signal frequency band of the RF circuit 16.

In contrast, the power clamp circuit 10 in the second power supply domain is coupled to the power supply line VDD-LINE2 and the ground line GND-LINE2 without providing junction elements therebetween, since the resonant signal has no adverse effects on the internal circuit 18.

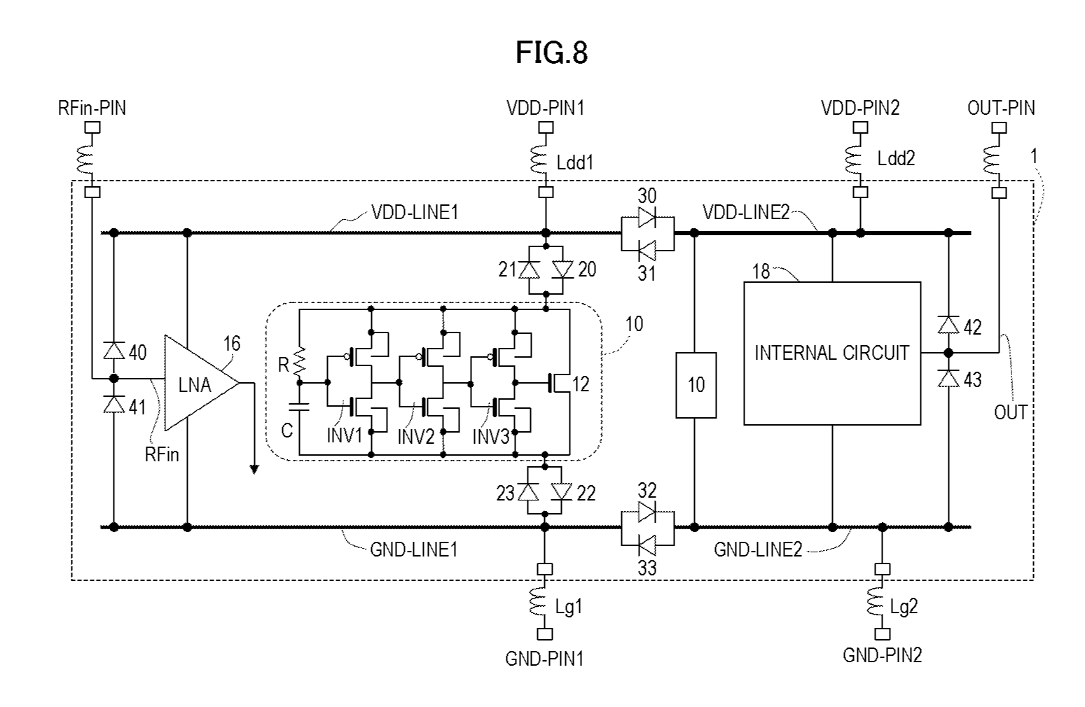

FIG. 8 is a diagram illustrating a modification of the second embodiment. The inverter INV of the power clamp circuit 10 is replaced by a 3-step structure INV1, INV2, and INV3. The rest of the structure is similar to the structure illustrated in FIG. 7. Also, the first power supply domain at the left of the IC chip 1 includes the RF circuit 16, and the power clamp circuit 10, which is between the power supply lines via the bidirectional diodes 20, 21, 22, and 23.

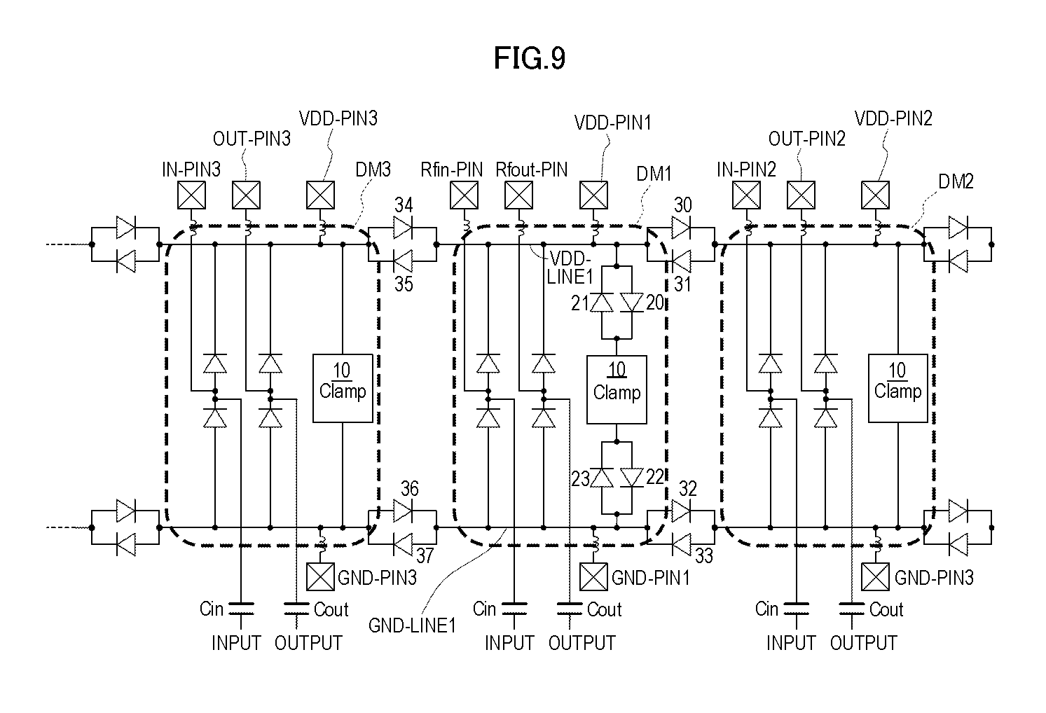

FIG. 9 is a diagram illustrating the details of the IC device of the second embodiment. The IC chip includes multiple power supply domains. Three power supply domains DM1, DM2, and DM3 are illustrated in FIG. 9. Power supply lines of each two of the power supply domains are coupled via bidirectional diode pairs 30 and 31, and 34 and 35. Ground lines of each two of the power supply domains are coupled via bidirectional diode pairs 32 and 33, and 36 and 37.

An RF circuit (not illustrated) is in the first power supply domain DM1, and one power clamp circuit 10 is coupled to the power supply line VDD-LINE1 via the bidirectional diode pair 20 and 21 and to the ground line GND-LINE1 via the bidirectional diode pair 22 and 23 so that a resonant circuit formed by parasitic inductances and a parasitic capacitance may have no adverse effects on a signal in an operating bandwidth. In contrast, no RF circuit is in the second power supply domain DM2 or the third power supply domain DM3, and internal circuits that process signals at lower frequencies are in the second and third power supply domains DM2 and DM3. Power clamp circuits 10 of the second and third power supply domains DM2 and DM3 are directly coupled to the power supply lines and the ground lines of the respective power supply domains.

Signal lines coupled to all external input terminals and external output terminals are coupled to the power supply lines and the ground lines via diodes. The electrical charge of ESD applied to these input signal lines and output signal lines is absorbed via these diodes by the power supply lines, the ground lines, and the power clamp circuits 10 between the power supply lines and the ground lines, thereby reducing if not preventing damage caused by ESD, of elements of the internal circuits.

As illustrated in the circuit diagram of FIG. 9, preferably the power supply line VDD-LINE1 and the ground line GND-LINE1 in the first power supply domain DM1 including the RF circuit are coupled to all of the power clamp circuits 10 in the chip via bidirectional diode pairs. Accordingly, the parasitic capacitance of any of these power clamp circuits 10 may be reduced, and the resonant frequency in the first power supply domain DM1 may be reduced.

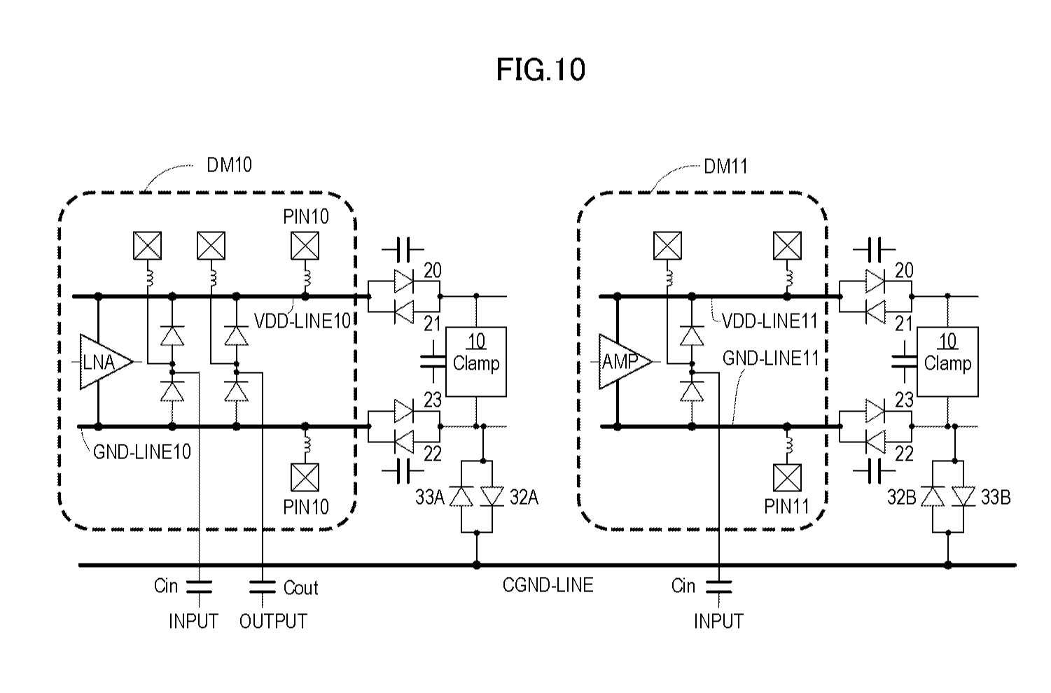

FIG. 10 is a diagram illustrating the details of an IC device of a third embodiment. Also, an IC chip includes two power supply domains DM10 and DM11, and power supply lines VDD-LINE10 and VDD-LINE11 and ground lines GND-LINE10 and GND-LINE11 of the two power supply domains DM10 and DM11 are directly coupled to external terminals PIN10 and PIN11, respectively, of a package. A low-noise amplifier LNA, which is an RF circuit, is in the power supply domain DM10. An amplifier AMP, which is also an RF circuit, is in the power supply domain DM11.

A power clamp circuit 10 is coupled between the power supply line and the ground line of each of the power supply domains DM10 and DM11 via the bidirectional diode pairs 20 and 21, and 22 and 23. With the parasitic capacitances of these bidirectional diode pairs 20 and 21, and 22 and 23, the parasitic capacitances of the power clamp circuits 10 between the respective power supply lines and the respective ground lines may be reduced.

The IC chip includes a common ground line CGND-LINE for forming a path that absorbs the electric charge of ESD between the power supply domains DM10 and DM11. The ground lines GND-LINE10 and GND-LINE11 of the power supply domains DM10 and DM11 are coupled via the common ground line CGND-LINE respectively to bidirectional diodes 32A, 33A, 32B, and 33B for power supply separation. The common ground line CGND-LINE is also coupled via the bidirectional diodes 32A, 33A, 32B, and 33B to the power clamp circuits 10.

Due to the structure, the electric charge of ESD applied between the different power supply domains DM10 and DM11 may be absorbed between the power supply lines VDD-LINE10 and VDD-LINE11 and the common ground line CGND-LINE via the power clamp circuits 10, or between the ground lines GND-LINE10 and GND-LINE11 and the common ground line CGND-LINE via the bidirectional diode pairs 32A and 33A, and 32B and 33B. Since the common ground line CGND-LINE is coupled to the ground lines GND-LINE10 and GND-LINE11 in the power supply domains DM10 and DM11 via the bidirectional diode pairs 32A and 33A, and 32B and 33B, the common ground line CGND-LINE is coupled to the outside via the external terminals PIN10 and PIN11 coupled to the ground lines GND-LINE10 and GND-LINE11.

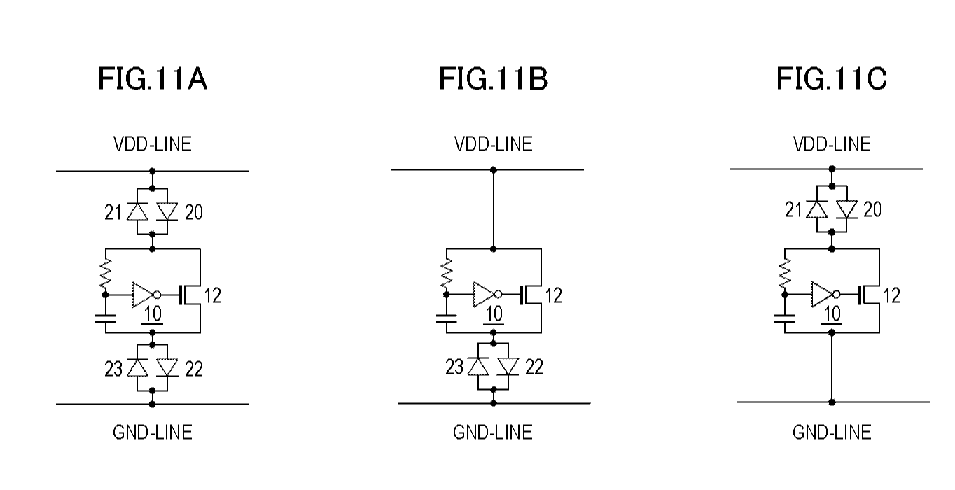

FIGS. 11A, 11B, and 11C illustrate combinations of a clamp circuit and junction elements according to the embodiments. FIG. 11A illustrates a combination of the power clamp circuit 10 and the junction elements 20, 21, 22, and 23 illustrated in FIG. 4. The power clamp circuit 10 is coupled to both the power supply line VDD-LINE and the ground line GND-LINE via the junction elements 20, 21, 22, and 23. In FIG. 11B, the power clamp circuit 10 is coupled to the ground line GND-LINE via the junction elements 22 and 23. In FIG. 11C, the power clamp circuit 10 is coupled to the power supply line VDD-LINE via the junction elements 20 and 21.

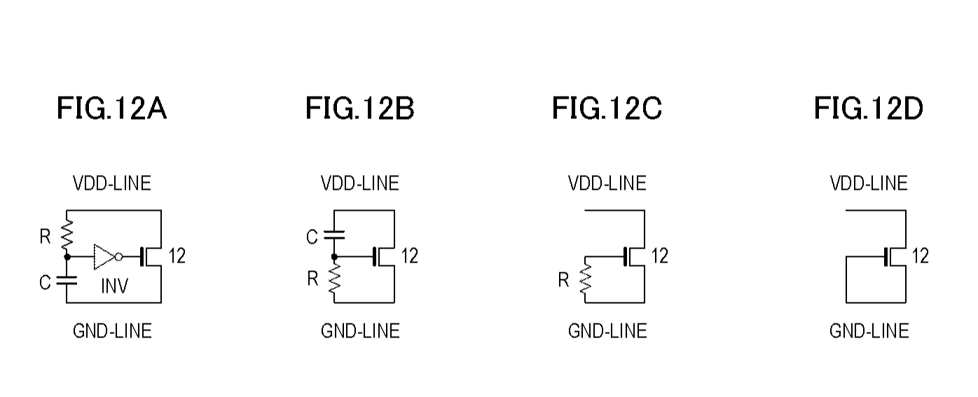

FIGS. 12A, 12B, 12C, and 12D illustrate structures of a clamp circuit according to the embodiments. FIG. 12A illustrates a power clamp circuit similar to the power clamp circuit 10 illustrated in FIG. 4. In the power clamp circuit illustrated in FIG. 12A, the connection node between the resistor R and the capacitor C is coupled to the gate of the clamp transistor 12 via the inverter INV. In FIG. 12B, there is no inverter, and the connection node between the capacitor C and the resistor R is coupled to the gate of the clamp transistor 12. Also, the connection node between the capacitor C and the resistor R becomes “H” level at substantially the same time at which the potential of the power supply line VDD-LINE increases, thereby causing the clamp transistor 12 to become electrically conductive.

In FIG. 12C, the gate of the clamp transistor 12 is coupled to the ground line GND-LINE side via the resistor R. Since the parasitic capacitance of the clamp transistor 12 is present between the gate and drain (power supply line VDD-LINE) of the clamp transistor 12, the operation is similar to the example illustrated in FIG. 12B. In FIG. 12D, the circuit between the gate of the clamp transistor 12 and the ground line GND-LINE is shorted. Also, since the parasitic capacitance is present between the gate and drain of the clamp transistor 12, the operation is similar to the example illustrated in FIG. 12B.

As described above, according to the embodiments, a resonant frequency due to parasitic inductances in power supply domains may be shifted to the outside of the operating frequency band of an internal circuit, thereby reducing degradation of the frequency characteristics of the internal circuit.

Although the embodiments in accordance with aspects of the present invention are numbered with, for example, “first,” “second,” or “third,” the ordinal numbers do not imply priorities of the embodiments. Many other variations and modifications will be apparent to those skilled in the art.

All examples and conditional language recited herein are intended for pedagogical purposes to aid the reader in understanding the aspects of the invention and the concepts contributed by the inventor to furthering the art, and are to be construed as being without limitation to such specifically recited examples and conditions, nor does the organization of such examples in the specification relate to a showing of the superiority and inferiority of the aspects of the invention. Although the embodiments in accordance with aspects of the present invention have been described in detail, it should be understood that various changes, substitutions, and alterations could be made hereto without departing from the spirit and scope of the invention.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. An integrated circuit device comprising:
a first power supply domain; and
a second power supply domain coupled to the first power supply domain via bidirectional diode pairs,
wherein the first power supply domain comprises:
a first power supply line and a second power supply line;
an internal circuit between the first power supply line and the second power supply line;
a first clamp circuit that electrically couples between the first power supply line and the second power supply line when a certain potential difference is generated between the first power supply line and the second power supply line; and
at least one of a junction element that is between the first clamp circuit and the first power supply line, and a junction element that is between the first clamp circuit and the second power supply line, the junction element allowing current to flow when the first clamp circuit becomes electrically conductive.

2. The integrated circuit device according to claim 1, wherein the junction element is a diode, and the first clamp circuit and the diode are coupled in series between the first power supply line and the second power supply line.

3. The integrated circuit device according to claim 2, wherein the second power supply domain comprises:
a third power supply line and a fourth power supply line;
an internal circuit between the third power supply line and the fourth power supply line; and
at least one of an intra-power-supply diode between the first power supply line and the third power supply line and an intra-power-supply diode between the second power supply line and the fourth power supply line.

4. The integrated circuit device according to claim 2, wherein the second power supply domain comprises:
a third power supply line and a fourth power supply line;
an internal circuit between the third power supply line and the fourth power supply line;
a common power supply line; and
an intra-power-supply diode electrically coupled between the second power supply line and the common power supply line and an intra-power-supply diode electrically coupled between the fourth power supply line and the common power supply line.

5. The integrated circuit device according to claim 3, wherein the internal circuit in the first power supply domain is a circuit that processes a signal at a frequency higher than a frequency of a signal processed by the internal circuit in the second power supply domain, and
wherein the integrated circuit device comprises a second clamp circuit electrically coupled between the third power supply line and the fourth power supply line without providing a junction element between the third power supply line and the fourth power supply line.

6. The integrated circuit device according to claim 1, wherein the first power supply line and the second power supply line are coupled to respective external terminals via bonding wires.

7. An integrated circuit device comprising:
an integrated circuit chip;
a package that includes the integrated circuit chip; and
a bonding wire that electrically couples an external terminal of the package to the integrated circuit chip,
wherein the integrated circuit chip comprises:
a first power supply line coupled to a first power supply external terminal via the bonding wire;
a second power supply line coupled to a second power supply external terminal via the bonding wire;
a radio frequency circuit that is electrically coupled between the first power supply line and the second power supply line and that processes a radio frequency signal;
a clamp circuit that is electrically coupled between the first power supply line and the second power supply line and that becomes electrically conductive when a voltage difference between the first power supply line and the second power supply line exceeds a certain threshold; and
at least one of a junction element between the clamp circuit and the first power supply line, and a junction element between the clamp circuit and the second power supply line, the junction element having a junction capacitance and allowing current to flow when the clamp circuit becomes electrically conductive.

8. The integrated circuit device according to claim 7, wherein the integrated circuit chip comprises:
a third power supply line coupled to a third power supply external terminal via the bonding wire;
a fourth power supply line coupled to a fourth power supply external terminal via the bonding wire;
an internal circuit electrically coupled between the third power supply line and the fourth power supply line; and
at least one of an intra-power-supply diode between the first power supply line and the third power supply line and an intra-power-supply diode between the second power supply line and the fourth power supply line.

9. The integrated circuit device according to claim 8, wherein the integrated circuit chip comprises:
the second power supply line and the fourth power supply line; and
a common power supply line coupled to the second power supply line and the fourth power supply line via the intra-power-supply diode.

10. The integrated circuit device according to claim 7, wherein the junction element is a diode, and
wherein the clamp circuit and the diode are coupled in series between the first power supply line and the second power supply line.

11. The integrated circuit device according to claim 7, wherein the junction element comprises a bidirectional diode pair, and
wherein the clamp circuit and the bidirectional diode pair are coupled in series between the first power supply line and the second power supply line.

12. The integrated circuit device according to claim 8, wherein the intra-power-supply diode comprises a bidirectional diode pair.

13. An integrated circuit device comprising:
an integrated circuit chip;
a package that includes the integrated circuit chip; and
a bonding wire that electrically couples an external terminal of the package to the integrated circuit chip,
wherein the integrated circuit chip comprises:
a first power supply line coupled to a first power supply external terminal via the bonding wire;
a second power supply line coupled to a second power supply external terminal via the bonding wire;
a first radio frequency circuit that is electrically coupled between the first power supply line and the second power supply line and that processes a radio frequency signal;
a first clamp circuit that is electrically coupled between the first power supply line and the second power supply line and that becomes electrically conductive when a voltage difference between the first power supply line and the second power supply line exceeds a certain threshold;
at least one of a first bidirectional diode pair between the first clamp circuit and the first power supply line, and a first bidirectional diode pair between the first clamp circuit and the second power supply line;
a third power supply line coupled to a third power supply external terminal via the bonding wire;
a fourth power supply line coupled to a fourth power supply external terminal via the bonding wire;
a second radio frequency circuit that is electrically coupled between the third power supply line and the fourth power supply line and that processes a radio frequency signal;
a second clamp circuit that is electrically coupled between the third power supply line and the fourth power supply line and that becomes electrically conductive when a voltage difference between the third power supply line and the fourth power supply line exceeds a certain threshold;
at least one of a second bidirectional diode pair between the second clamp circuit power and the third power supply line and a second bidirectional diode pair between the second clamp circuit and the fourth power supply line; and
a common power supply line coupled to the second power supply line and the fourth power supply line via the first bidirectional diode pair and the second bidirectional diode pair.
